(19) United States
(12) Patent Application Publication
(10) Pub. No.: US 2021/0186270 A1
(43) Pub. Date: Jun. 24, 2021

(54) FASTENING ELEMENT FOR AN ACCESSORY PART FOR A PAIL, ACCESSORY PART AND PAIL

(71) Applicant: Thomas Hackner, Idstein (DE)

(72) Inventors: Thomas Hackner, Idstein (DE); Dietmar Hackner, Waldems (DE); Marcus Gottwald, Ober-Ramstadt (DE); Jens Schnur, Oberzent (Olfen) (DE)

(73) Assignee: Thomas Hackner, Idstein (DE)

(21) Appl. No.: 15/733,627

(22) PCT Filed: Mar. 18, 2019
(86) PCT No.: PCT/EP2019/056693

§ 371 Date: Sep. 18, 2020

(30) Foreign Application Priority Data
Mar. 19, 2018 (LU) 100741

(51) Int. Cl. A47J 47/18; A45F 5/02

(52) U.S. Cl. CPC A47J 47/18; A45F 2200/0575; A45F 5/02

(57) ABSTRACT

A fastening element of an accessory part for a pail extends along a circular arc. The fastening element includes a first profile element having a U-shaped cross section and first and second profile legs. The legs are interconnected by a first profile web and arranged opposite one another. The profile legs have a first minimum distance from one another. The fastening element also includes a second profile element having a U-shaped cross section with third and fourth profile legs. Those are interconnected by a second profile web and are arranged opposite one another. The third and the fourth profile legs have a second minimum distance from one another. The second minimum distance is greater than the first minimum distance.

### TECHNICAL FIELD

The disclosure relates to a fastening element of an accessory part for a pail.

### BACKGROUND

Pails are well known in practice, in particular for the washing or maintenance of motor vehicles. American-style US gallon pails are used for this purpose, for example. Car washing often takes place at public car-washing stations. At these car-washing stations, washing water is provided which can be placed into the pails and used for washing vehicles. Since the washing water provided at car-washing stations is often only of service-water quality, some particularly demanding car owners also use their own water they have brought with them in their own pails for washing their cars.

For transporting these pails filled with the washing liquid in motor vehicles, the pails usually have lids, which seal the pails in a watertight manner to prevent the washing liquid from spilling. Two-part lids are most commonly used for this purpose, with a lid edge being sealingly clipped to the edge of the pail and an inner part of the lid being able to be sealingly screwed into the lid edge.

Various sponges, cloths and brushes are used when washing or carrying out maintenance on motor vehicles. In order for it to be possible to temporarily attach cleaning items of this kind to the pail, it is known to attach accessory parts of this kind to the edge of the pail using suitable fastening elements. In practice, however, fastening elements for accessory parts which allow said parts to be rapidly and easily attached in a detachable manner both to the edge of the pail and to the pail when it has a lid edge attached thereto are not known.

### SUMMARY

The object of the present disclosure is to provide a fastening element that can be rapidly and easily attached in a detachable manner both to the edge of the pail and to the pail when it has a lid edge attached thereto.

This object is achieved in that the fastening element comprises a second profile element having a U-shaped cross section having third and fourth profile legs, which are interconnected by a second profile web and are arranged opposite one another, wherein the third and the fourth profile legs have a second minimum distance from one another in the radial direction in a second receiving region for a second pail edge, which second receiving region is provided for the pail, and the second minimum distance is greater than the first minimum distance. The fastening element extends along the circular arc, the radius of which is adapted to a radius of the relevant pail. The radial direction of the fastening element corresponds to the radial direction of the circular arc, wherein the radial direction extends towards a central point of the circular arc.

The fastening element has a simple design and can be used for rapid and easy, temporary attachment to the first pail edge, which is formed by an upper open end of the pail, as well as to the second pail edge, which is formed by the upper open end of the pail when it has a lid edge attached thereto. The fastening element comprises the first and the second profile element, wherein the first profile element enables detachable attachment to the first pail edge and the second profile element enables detachable attachment to the second pail edge. The first pail edge is attached in a first receiving region between the first and the second profile legs and the second pail edge is attached in a second receiving region between the third and the fourth profile legs. When the fastening element is used as intended, the first profile leg of the first profile element and/or the third profile leg of the second profile element is outside the pail. The second or the fourth profile legs engage in the interior of the pail.

The lid edge has a greater width than the pail edge. Therefore, in the fastening element, it is provided that the second minimum distance is greater than the first minimum distance. The first minimum distance is advantageously adapted to the width of the pail edge, while the second minimum distance is advantageously adapted to the width of the lid edge.

The first profile element and the second profile element may be formed beside one another in a circumferential direction of the fastening element. However, it is also possible and particularly advantageously provided that the profile elements are arranged in the radial direction so as to be adjacent to one another. By means of the adjacent arrangement of the profile elements, the total length of the fastening element in the circumferential direction can be used both for fastening to the pail edge and to the lid edge.

Advantageously, the fastening element comprises at least one first leg element, wherein the first leg element forms a profile leg of the first and the second profile element in each case. In this case, the leg element is used both as a profile leg of the first profile element and as a profile leg of the second profile element. When the profile elements are arranged beside one another in the circumferential direction, the profile elements can be interconnected by the first leg element in order to increase the stability of the fastening element.

When the two profile elements overlap at least in part in the radial direction, the total width of the fastening element in the radial direction can be reduced by using the common first leg element, since the first and the second minimum distance can each be predetermined by the common first leg element.

It is advantageously provided that the first leg element forms the second profile leg of the first profile element and the third profile leg of the second profile element. It is also possible that at least one profile leg and/or at least one leg element and/or at least one profile web is bent or angled.

A particularly advantageous embodiment provides that the first profile web of the first profile element forms a portion of the second profile web of the second profile element. By integrating the first profile web in the second profile web, the extension of the fastening element in the radial direction can be shortened further.

Advantageously, it may be provided that, when the fastening element is used as intended, the first and the third profile leg are outside the pail and the second and the fourth profile leg are inside the pail, wherein the fastening element comprises a leg element which forms the first and the third profile leg.

An advantageous implementation of the inventor's concept provides that correction planes of the first and/or the second U-shaped profile element, which planes extend through the profile legs, are arranged at an angle of from 0.1 to 25 degrees to one another, wherein the distance between the profile legs increases as the distance from the relevant profile web increases. The profile legs may have a planar, bent or even rounded shape. Correction planes which extend through the profile legs and are each the minimum distance possible from the respective profile legs advantageously intersect in this case. The profile legs of the first and/or the second profile element, which spread apart towards the opening of the U-shaped profile, may be adapted to the semi-circular shape of the relevant pail edge. Furthermore, the insertion of the relevant pail edge into the associated receiving region is made easier by arranging the profile legs at an angle to one another. In addition, by means of the elastic deformation of the relevant profile leg when inserting the associated pail edge, the fastening element is clamped tight on the associated pail edge in a force-fitting manner.

In an advantageous embodiment of the fastening element, it is provided that at least one abutment part is formed on at least one profile leg, wherein the abutment part is oriented towards the opposite profile leg of the relevant profile element.

The first pail edge is formed by an approximately semi-circular fold pointing outwards from a pail wall, wherein the pail edge and the fold being are in one piece and the pail edge transitions into the fold. If the first pail edge is inserted into the first receiving region of the first profile, the semi-circular portion of the first pail edge can be attached in a force-fitting manner by elastic deformation of the two profile legs of the first profile element. In another advantageous embodiment of the fastening element, a first abutment part, which engages behind the fold, may be formed on the first profile leg opposite the pail wall, meaning that the fastening element can be attached to the pail edge in an interlocking manner. In another advantageous embodiment of the fastening element, a second abutment part, which engages behind the second lid edge on the inside of the pail, is formed on the fourth profile leg.

It is advantageously provided that the fastening element attached to the first or second pail edge can be detached by tilting the fastening element towards the pail, wherein it is possible for the relevant abutment part to be detached from the relevant pail edge by elastic deformation of the first or the second profile element by the respective profile legs opening relative to another.

An advantageous embodiment of the fastening element provides that an abutment part is formed within the second profile element by the second profile leg. The second receiving region of the fastening element is inevitably larger than the first receiving region. If the first and the third profile legs are combined in one first leg element, the second profile leg is positioned approximately within the center of the second receiving region. In order to adapt the shape of the abutment parts arranged on the first and fourth profile legs towards a pail base to the first and the second pail edge, the second profile leg may be formed as an abutment part for the second pail edge within the second profile element. Advantageously, a length of the second profile leg is intended to be adapted to a height of the first lid edge and a length of the fourth profile leg is intended to be adapted to a height of the second lid edge.

In an advantageous embodiment of the fastening element, it is provided that the fastening element comprises a first leg element adjacent to the accessory part, wherein a profile leg of each of the first and the second profile element is formed by the first leg element, a molded portion is formed on the first leg element, the molded portion forms a first abutment part of the first profile element and, when the fastening element is used as intended, is able to engage behind the first pail edge, wherein the molded portion of the first leg element forms a third abutment part relative to the second pail edge, wherein the first leg element is connected to the first profile leg at an obtuse angle and the first profile leg connecting the first leg element to a second leg element, wherein the second leg element forms the second profile leg of the first profile element as well as a fourth abutment part of the second profile element, wherein the first profile leg forms a portion of the second profile leg and attaches a portion of the second profile leg that extends beyond the first profile leg to the first profile leg at an obtuse angle, and the second profile leg connects the first leg element to the fourth profile leg at an obtuse angle, wherein the fourth profile leg has a second abutment part which, when the fastening element is used as intended, can engage behind the second pail edge.

A fastening element of this kind is designed such that it can be rapidly and easily detachably attached both to the US gallon pails that are used in practice and to pails of this kind provided with a lid edge. This is achieved by the first pail edge being able to be attached in a first receiving region between the first profile leg, which is part of the first leg element, and the second profile leg, an abutment part formed on the first leg element engaging behind the fold of the first pail edge. Furthermore, the second pail edge can be attached in a second receiving region between the third profile leg and the fourth profile leg, wherein the second pail edge abuts the second profile leg towards the pail opening and a second abutment part formed on the fourth profile leg engages behind said second pail edge on the inside of the pail. The fastening element engages behind one of the two pail edges and secures the accessory part joined to the fastening element against unintentionally becoming detached.

In an advantageous embodiment of the fastening element, it is provided that the first and/or the second profile element is formed along the fastening element in certain regions so as to follow the circular-arc shape. By forming at least one of the profile elements along the fastening element in certain regions, the fastening element can be constructed to be lighter and more cost-effective. It is possible that the first profile element is formed continuously along the circular arc of the fastening element and the second profile element is formed along the circular arc of the fastening element in certain regions. Furthermore, it is possible for the first and the second profile element to be formed together along the circular arc of the fastening element in certain regions.

An advantageous implementation of the concept of the invention provides that a radius of the circular arc along which the fastening element extends is adapted to a pail radius. The radius of the circular arc or a radius of the fastening element is adapted to a radius of the pail to which the fastening element is attached, such that the fastening element can be rapidly and easily attached to the relevant pail edge.

The disclosure also relates to an accessory part for a pail comprising a fastening element as described above.

In an advantageous embodiment of the accessory part, it is provided that the accessory part and the fastening element are formed in one piece. It is possible that the accessory part is produced together with the fastening element in an injection-molding process. It is, however, also possible that the accessory part is joined to or injection-molded onto the fastening element in the injection-molding process, or that the fastening element is joined to or injection-molded onto the accessory part in the injection-molding process. Furthermore, it is possible that additional accessory-part modules can be joined to the accessory part in the circumferential direction.

Advantageously, it is provided that the side wall of the accessory part, which faces the pail when the accessory part is used as intended, is adapted to the shape of the pail. The volume of a container that is attached to the pail as an accessory part can be maximized while maintaining the same external dimensions by the side wall of the accessory part facing the pail being adapted to the pail. In an advantageous embodiment, the accessory part is attached to the outside of the pail by means of the fastening element. In another advantageous embodiment, said accessory part is attached to the inside of the pail by means of the fastening element. In another advantageous embodiment, the accessory part and the fastening element are formed in at least two pieces, wherein the accessory part comprises a first side and a second side, wherein the first side is adapted to the outer shape of the pail and the second side is adapted to the inner shape of the pail, wherein it is possible for the fastening element to be detachably attached to the first and the second side in order for the accessory part to be able to be detachably attached both to the inside and to the outside of the pail. In another advantageous embodiment of the accessory part with the first side adapted to the outer shape of the pail and the second side adapted to the inner shape of the pail, the first and the second side of the accessory part are opposite one another.

Advantageously, the accessory part is a container for receiving sponges or wash cloths. The container comprises a container opening and a container base that is opposite the container opening and is connected to a container wall that surrounds a container interior. At least one drainage opening can be provided in the container base, through which washing water dripping out of a sponge into the container interior can drain out of the container.

The disclosure also relates to a pail comprising an accessory part as described above.

In an advantageous embodiment of the pail, it is provided that the pail has an upper open end and a lower closed end, the upper open end of the pail forming the first pail edge, wherein the first pail edge comprises the fold that points outwards, wherein the fastening element is detachably attached to the first pail edge when used as intended, wherein the first abutment part of the fastening element engages behind the fold of the pail in order to prevent the accessory part from becoming detached from the pail towards the upper open end of the pail. The accessory part is rapidly and easily fastened to the first pail edge by means of the fastening element and is secured against unintentionally becoming detached from the pail.

An advantageous implementation of the inventor's concept provides that a lid edge is detachably attached to the first pail edge, wherein the second pail edge is formed by the first pail edge together with the fixed lid edge, wherein the lid edge abuts an inner face of the pail in an interlocking manner, a second abutment part of the fastening element engages behind a boundary of the lid edge towards the closed end of the pail so as to rest on the inner face of the pail in order to prevent the accessory part from becoming detached from the pail towards the upper open end of the pail. The accessory part is rapidly and easily fastened to the second pail edge by means of the fastening element and is secured against unintentionally becoming detached from the pail.

### BRIEF DESCRIPTION OF THE DRAWINGS

FIG. 1 is a schematic view of a section through a fastening element that is attached to a first pail edge,

FIG. 2 is a schematic view of a section through the fastening element attached to a second pail edge as shown in FIG. 1,

FIGS. 3 and 4 are schematic views of an accessory part comprising the integrated fastening element.

### DETAILED DESCRIPTION

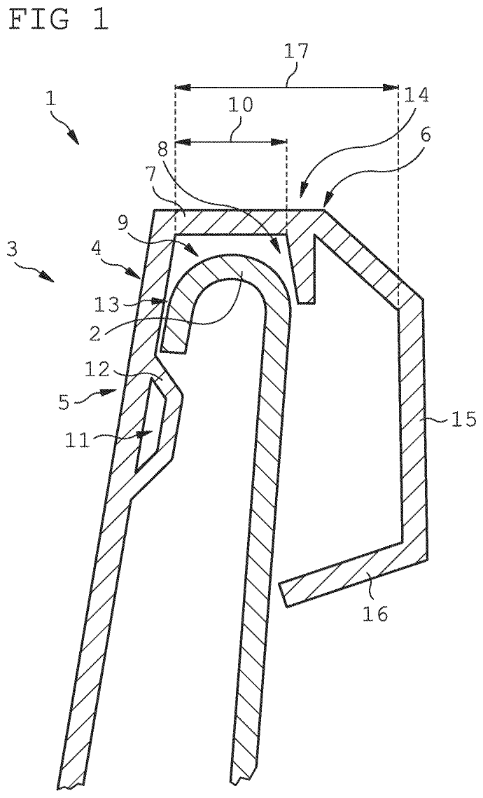

FIG. 1 schematically shows a fastening element 1 that is attached to a first pail edge 2. The fastening element 1 comprises a first leg element 3. The first leg element 3 forms a first profile leg 4 and a third profile leg 5. The fastening element 1 also comprises a second leg element 6. The second leg element 6 is connected to the first leg element 3 by a first profile web 7. The first pail edge 2 is attached in the first receiving region 9 between the first profile leg 4 and a second profile leg 8. The first profile leg 4 and the second profile leg 8 have a first minimum distance 10 from one another in a radial direction 27. The first leg element 3 also forms a molded portion 11, which forms a first abutment part 12. The first abutment part 12 engages behind a fold 13 of the first pail edge 2. The abutment part 12 secures the fastening element 1 against unintentionally becoming detached from the first pail edge 2. The first profile web 7 forms a portion of a second profile web 14, the second profile web 14 connecting the first leg element 3 to a fourth profile leg 15. The fourth profile leg 15 comprises a second abutment part 16, which abuts the first pail edge 2. The third profile leg 5 and the fourth profile leg 15 have a second minimum distance 17 from one another.

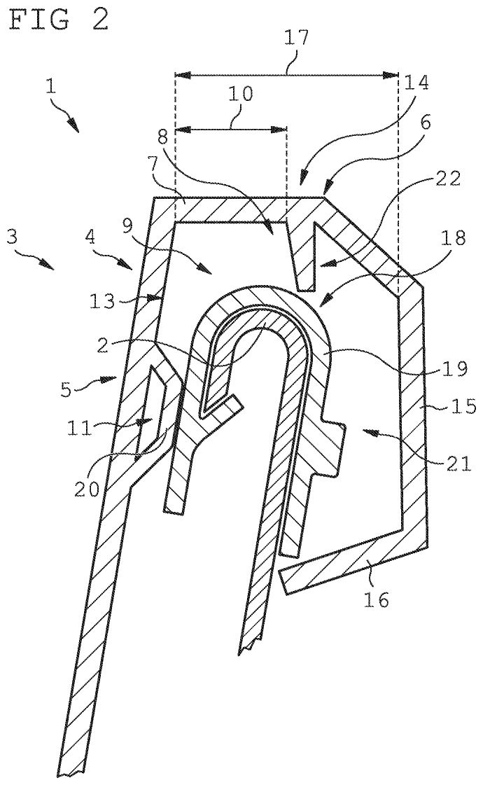

FIG. 2 shows the fastening element 1 shown schematically in FIG. 1 so as to be attached to a second pail edge 18. The second pail edge 18 is formed by the first pail edge 2 with a fixed lid edge 19. The second pail edge 18 is attached in a second receiving region 21 between a third abutment part 20 of the third profile leg 5 and the second abutment part 16 of the fourth profile leg 15. The second profile leg 8 forms a fourth abutment part 22 in relation to the second pail edge 18. The second abutment part 16 engages behind the lid edge 19 attached to the first pail edge 2. The fastening element 1 is secured against becoming detached from the second pail edge 18 in this way.

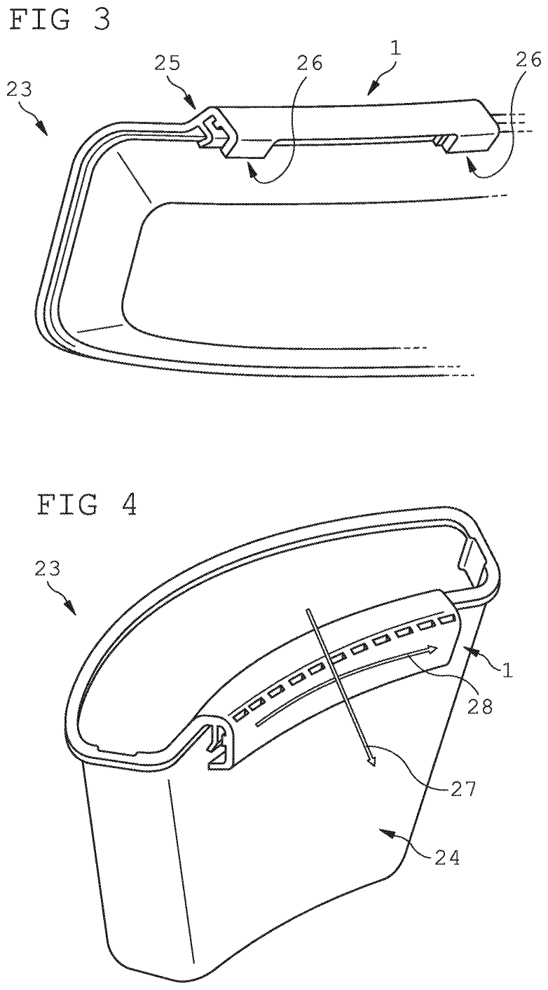

FIG. 3 is a schematic bottom view of an accessory part 23 and FIG. 4 is a schematic side view of the accessory part 23. Both the fastening element 1 and the inner wall 24 of the accessory part 23 are adapted to the radius of a pail. A first profile element 25 is formed along the entire fastening element 1 and a second profile element 26 is only formed in certain regions. The figure shows a radial direction 27 and a circumferential direction 28 of the fastening element.

### LIST OF REFERENCE SIGNS

1 Fastening element
2 First pail edge
3 First leg element
4 First profile leg
5 Third profile leg
6 Second leg element
7 First profile web
8 Second profile leg
9 First receiving region
10 First minimum distance
11 Molded portion
12 First abutment part
13 Fold
14 Second profile web
15 Fourth profile leg
16 Second abutment part
17 Second minimum distance
18 Second pail edge
19 Lid edge
20 Third abutment part
21 Second receiving region
22 Fourth abutment part
23 Accessory part
24 Inner wall
25 First profile element
26 Second profile element
27 Radial direction
28 Circumferential direction

1.-12. (canceled)

13. A fastening element (1) of an accessory part (23) for a pail,
wherein the fastening element (1) extends along a circular arc,
wherein the fastening element (1) comprises
a first profile element (25) having a U-shaped cross section having first (4) and
second (8) profile legs, which are interconnected by a first profile web (7) and are arranged opposite one another,
wherein the first (4) and the second (8) profile legs have a first minimum distance (10) from one another in a radial direction (27) of the fastening element (1) in a first receiving region (9) for a first pail edge (2), which first receiving region is provided for the pail,
wherein the fastening element (1) comprises a second profile element (26) having a U-shaped cross section having third (5) and fourth (15) profile legs, which are interconnected by a second profile web (14) and are arranged opposite one another,
wherein the third (5) and the fourth (15) profile legs have a second minimum distance (17) from one another in the radial direction (27) in a second receiving region (21) for a second pail edge (18), which second receiving region is provided for the pail, and
wherein the second minimum distance (17) is greater than the first minimum distance (10).

14. The fastening element (1) of an accessory part (23) for a pail according to claim 13, wherein the first profile web (7) of the first profile element (25) forms a portion of the second profile web (14) of the second profile element (26).

15. The fastening element (1) of an accessory part (23) for a pail according to claim 13,
wherein correction planes of the first (25) and/or the second (26) U-shaped profile element, which planes extend through the profile legs (4, 5, 8, 15), are arranged at an angle of from 0.1 to 25 to one another,
wherein the distance between the profile legs (4, 5, 8, 15) increases as the distance from the relevant profile web (7, 14) increases.

16. The fastening element (1) of an accessory part (23) for a pail according to claim 13,
wherein at least one abutment part (12, 16, 20, 22) is formed on at least one profile leg (4, 5, 8, 15),
wherein the abutment part (12, 16, 20, 22) is oriented towards the opposite profile leg (4, 5, 8, 15) of the relevant profile element (25, 26).

17. The fastening element (1) of an accessory part (23) for a pail according to claim 16, wherein an abutment part (22) is formed by the second profile leg (8) of the second profile element (26).

18. The fastening element (1) of an accessory part (23) for a pail according to claim 16,
wherein the fastening element (1) comprises a first leg element (3) adjacent the accessory part (23),
wherein a profile leg (4, 5) of each of the first (25) and the second (26) profile element is formed by the first leg element (3),
wherein a molded portion (11) is formed on the first leg element (3),
wherein the molded portion (11) forms a first abutment part (12) of the first profile element (25) and, when the fastening element is used as intended, is able to engage behind the first pail edge (2),
wherein the molded portion (11) of the first leg element (3) forms a third abutment part (20) relative to the second pail edge (18),
wherein the first leg element (3) is connected to the first profile leg (7) at an obtuse angle and the first profile leg (7) connects the first leg element (3) to a second leg element (6),
wherein the second leg element (6) forms the second profile leg (8) of the first profile element (25) as well as a fourth abutment part (22) of the second profile element (26),
wherein the first profile leg (7) forms a portion of the second profile leg (14) and attaches a portion of the second profile leg (14) that extends beyond the first profile leg (7) to the first profile leg (7) at an obtuse angle, and the second profile leg (14) connects the first leg element (3) to the fourth profile leg (15) at an obtuse angle,
wherein the fourth profile leg (15) has a second abutment part (16) which, when the fastening element is used as intended, can engage behind the second pail edge (18).

19. The fastening element (1) of an accessory part (23) for a pail according to claim 13, wherein the first (25) and/or the second (26) profile element is formed along the fastening element (1) in certain regions so as to follow the circular-arc shape.

20. The fastening element (1) of an accessory part (23) according to claim 13, wherein a radius of the circular arc along which the fastening element (1) extends is adapted to a pail radius.

21. The accessory part (23) for a pail comprising a fastening element according to claim 13, wherein the accessory part (23) and the fastening element (1) are formed in one piece.

22. The accessory part (23) for a pail comprising a fastening element according to claim 13, wherein the side wall (24) of the accessory part (23), which faces the pail when the accessory part (23) is used as intended, is adapted to the shape of the pail.

23. A pail comprising the accessory part according to claim 21,
wherein the pail comprises an upper open end and a lower closed end,
wherein the upper open end of the pail forms the first pail edge (2),
wherein the first pail edge (2) comprises a fold (13) that points outwards,
wherein the fastening element (1) is detachably attached to the first pail edge (2) when used as intended,
wherein a first abutment part (12) of the fastening element (1) engages behind the fold (13) of the pail in order to prevent the accessory part (23) from becoming detached from the pail towards the upper open end of the pail.

24. A pail comprising the accessory part according to claim 21,
wherein a lid edge (19) is detachably attached to the first pail edge (1),
wherein the second pail edge (18) is formed by the first pail edge (2) together with the fixed lid edge (19),
wherein the lid edge (19) abuts an inner face of the pail in an interlocking manner,
wherein a second abutment part (16) of the fastening element (1) engages behind a boundary of the lid edge (19) towards the closed end of the pail so as to rest on the inner face of the pail in order to prevent the accessory part (23) from becoming detached from the pail towards the upper open end of the pail.
